(19) United States
(12) Patent Application Publication
(10) Pub. No.: US 2013/0020895 A1
(43) Pub. Date: Jan. 24, 2013

(54) APPARATUS, SYSTEM AND METHOD FOR DETECTING ANOMALOUS AXIAL DISPLACEMENTS OF A MAGNETICALLY LEVITATED FLYWHEEL IN AN ELECTROMECHANICAL BATTERY SYSTEM AND RELATED SYSTEMS AND METHODS

(71) Applicants: Philip J. SCALZO, North Salt Lake, UT (US); Carleton D. TAIT, North Salt Lake, UT (US)

(72) Inventors: Philip J. SCALZO, North Salt Lake, UT (US); Carleton D. TAIT, North Salt Lake, UT (US)

(73) Assignee: EMB Energy, Inc., Edmonton, OK (US)

(21) Appl. No.: 13/531,121

(22) Filed: Jun. 22, 2012

Related U.S. Application Data
(60) Provisional application No. 61/500,405, filed on Jun. 23, 2011.
(60) Provisional application No. 61/500,382, filed on Jun. 23, 2011.
(60) Provisional application No. 61/500,355, filed on Jun. 23, 2011.
(60) Provisional application No. 61/500,370, filed on Jun. 23, 2011.
(60) Provisional application No. 61/500,394, filed on Jun. 23, 2011.

(51) Int. Cl. H02K 7/09

(52) U.S. Cl. 310/90.5

(57) ABSTRACT

A magnetic-stabilizer bearing apparatus is described for stabilizing the magnetic bearing of an electromechanical battery (EMB) system, which includes a magnetic bearing arrangement having magnetic-stabilizer bearing elements, at least two Halbach arrays attached to the flywheel with a fixed conductive element positioned in-between each of the arrays and an EMB flywheel, and a control arrangement to monitor the current and detect an anomalous axial displacement of the flywheel from its equilibrium position if currents measured by the control arrangement exceed a characterized distribution of currents. Also described is a related method for stabilizing a magnetic bearing of an electromechanical battery (EMB) system.

### RELATED APPLICATION INFORMATION

The present application is a utility application of and claims the benefit of and priority to U.S. Provisional Patent Application Ser. No. 61/500,405, filed Jun. 23, 2011 (attorney docket no. 15223/8), which is hereby incorporated by reference. The present application is also a utility application of and claims the benefit of and priority to U.S. Provisional Patent Application Ser. No. 61/500,382, filed Jun. 23, 2011 (attorney docket no. 15223/5), which is hereby incorporated by reference. The present application is also a utility application of and claims the benefit of and priority to U.S. Provisional Patent Application Ser. No. 61/500,355, filed Jun. 23, 2011 (attorney docket no. 15223/2), U.S. Provisional Patent Application Ser. No. 61/500,370, filed Jun. 23, 2011 (attorney docket no. 15223/3), and U.S. Provisional Patent Application Ser. No. 61/500,394, filed Jun. 23, 2011 (attorney docket no. 15223/6), all of which are hereby incorporated by reference.

### FIELD OF THE INVENTION

The present invention relates to an apparatus, system and method for detecting anomalous axial displacements of a magnetically levitated flywheel in an electro-mechanical battery (EMB) system.

### BACKGROUND INFORMATION

The Electro-Mechanical Battery (EMB) is a bulk electric energy storage device that is believed to provide a practical solution to many of the shortcomings of renewable energy technologies, such as the diurnal nature of wind and solar intermittency. The EMB should be considered an enabling technology because of its economically competitive ability to level net power delivery to the electric grid, resulting in a higher transmission line utilization factor.

Electromechanical Batteries (EMB) may store considerable amounts of energy in the form of kinetic energy imparted to a rotating flywheel. For example, in an EMB Energy system at full charge, there may be more than 900 MJ or 300 kWhs of energy stored in the 3000 Kg flywheel rotating at nearly 14,000 RPM. The kinetic energy stored in the EMB flywheel is proportional to the square of its rotational velocity (ω).

The flywheel of the EMB may include a thick-walled cylinder made of filament wound glass and carbon fiber. Under normal, steady-state operations, the EMB flywheel may be magnetically levitated, and the high rotational velocity of the flywheel causes it to present gyroscopic behavior. If magnetically levitated, the flywheel has no physical connection to its containment vessel, and it is able to rotate about its axis independent of the containment vessel.

A magnetic bearing system for an electromechanical battery (EMB) contains magnetic subsystems which act together to support a rotating element in a state of dynamic equilibrium. Stable equilibrium is achieved above a critical speed by using a collection of passive elements using permanent magnets. In an EMB with a vertical rotational axis, levitation magnets provide radial stabilization through the predominant attractive magnetic forces between magnets on the top of the flywheel and the top of the supporting structure. However, achieving radial stabilization implies that axial stabilization along the rotational axis is unstable (Earnshaw's Theorem).

### SUMMARY OF THE INVENTION

The exemplary embodiments and/or exemplary methods of the present invention relate to a magnetic-stabilizer bearing apparatus for stabilizing the magnetic bearing of an electromechanical battery (EMB) system, which includes a magnetic bearing arrangement having magnetic-stabilizer bearing elements, at least two Halbach arrays attached to the flywheel with a fixed conductive element positioned in-between each of the Halbach arrays and a flywheel of the EMB, and a control arrangement to monitor the current, in which the control arrangement detects an anomalous axial displacement of the flywheel from its equilibrium position if currents measured by the control arrangement exceed a characterized distribution of currents. In particular, the present system provides for monitoring the current from the axial stabilization system to detect an anomaly or anomalous behavior and to correct and/or stop the flywheel when the anomaly or anomalous behavior exceeds a predetermined level.

The exemplary embodiments and/or exemplary methods of the present invention also relate to the foregoing apparatus in which the control arrangement corrects, slows or stops flywheel operation before the flywheel fails.

The exemplary embodiments and/or exemplary methods of the present invention also relate to the foregoing apparatus in which the conductive element includes wound Litz wire.

The exemplary embodiments and/or exemplary methods of the present invention also relate to the foregoing apparatus in which the control arrangement determines an initial characteristic distribution of currents.

The exemplary embodiments and/or exemplary methods of the present invention also relate to the foregoing apparatus in which the control arrangement corrects, slows or stops flywheel operation before the flywheel fails, and wherein the conductive element includes wound Litz wire.

The exemplary embodiments and/or exemplary methods of the present invention also relate to the foregoing apparatus in which the control arrangement corrects, slows or stops flywheel operation before the flywheel fails, and wherein the control arrangement determines an initial characteristic distribution of currents.

The exemplary embodiments and/or exemplary methods of the present invention also relate to the foregoing apparatus in which the control arrangement corrects, slows or stops flywheel operation before the flywheel fails, wherein the conductive element includes wound Litz wire, and wherein the control arrangement determines an initial characteristic distribution of currents.

The exemplary embodiments and/or exemplary methods of the present invention also relate to the foregoing apparatus in which when the spinning flywheel moves axially away from a desired equilibrium position, one of the Halbach arrays moves closer to the fixed conductive element, causing an electric current to produce counter-magnetic force in the fixed conductive element to nudge the Halbach array back to the equilibrium position.

The exemplary embodiments and/or exemplary methods of the present invention also relate to the foregoing apparatus in which the control arrangement corrects, slows or stops flywheel operation before the flywheel fails, and wherein the conductive element includes wound Litz wire.

The exemplary embodiments and/or exemplary methods of the present invention also relate to the foregoing apparatus in which the control arrangement corrects, slows or stops flywheel operation before the flywheel fails, and wherein the control arrangement determines an initial characteristic distribution of currents.

The exemplary embodiments and/or exemplary methods of the present invention also relate to the foregoing apparatus in which the control arrangement corrects, slows or stops flywheel operation before the flywheel fails, wherein the conductive element includes wound Litz wire, and wherein the control arrangement determines an initial characteristic distribution of currents.

The exemplary embodiments and/or exemplary methods of the present invention also relate to a method for stabilizing a magnetic bearing of an electromechanical battery (EMB) system, the method including determining a characteristic distribution of currents of a magnetic bearing arrangement having magnetic-stabilizer bearing elements, in which at least two Halbach arrays attached to the flywheel with a fixed conductive element are positioned in-between each of the Halbach arrays and a flywheel of the EMB, monitoring and measuring the current, comparing the measured currents and the initial characteristic distribution of currents, and determining that there is an anomalous axial displacement of the flywheel from its equilibrium position if the measured currents measured exceed the characteristic distribution of currents.

The exemplary embodiments and/or exemplary methods of the present invention also relate to the foregoing method that further includes at least one of correcting, slowing or stopping flywheel operation before the flywheel fails.

The exemplary embodiments and/or exemplary methods of the present invention also relate to the foregoing method in which the conductive element includes wound Litz wire.

The exemplary embodiments and/or exemplary methods of the present invention also relate to the foregoing method that further includes at least one of correcting, slowing or stopping flywheel operation before the flywheel fails, in which the conductive element includes wound Litz wire.

The exemplary embodiments and/or exemplary methods of the present invention also relate to the foregoing method in which when the spinning flywheel moves axially away from a desired equilibrium position, one of the Halbach arrays moves closer to the fixed conductive element, causing an electric current to produce counter-magnetic force in the fixed conductive element to nudge the Halbach array back to the equilibrium position.

The exemplary embodiments and/or exemplary methods of the present invention also relate to the foregoing method that further includes at least one of correcting, slowing or stopping flywheel operation before the flywheel fails, in which the conductive element includes wound Litz wire.

### BRIEF DESCRIPTION OF THE DRAWINGS

FIG. 1 shows an exemplary embodiment of a magnetic-stabilizer bearing apparatus, system and method for stabilizing the magnetic bearing of an electromechanical battery (EMB) system.

FIG. 2 shows an EMB with a control arrangement coupled to the Magnetic Stabilizer Bearing of the EMB.

### DETAILED DESCRIPTION

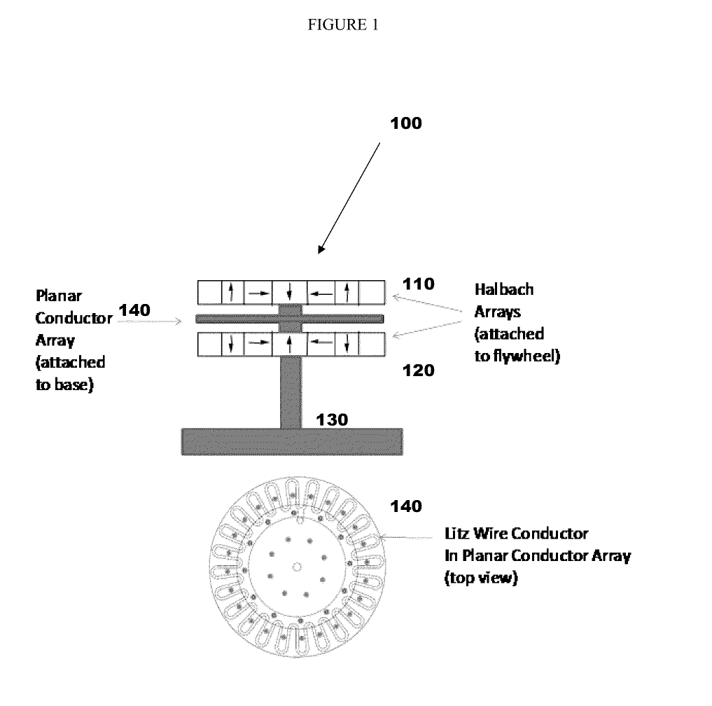

FIG. 1 shows an exemplary embodiment of a magnetic-stabilizer bearing apparatus, system and method for stabilizing the magnetic bearing of an electromechanical battery (EMB) system.

In particular, FIG. 1 shows an exemplary embodiment of a magnetic-stabilizer bearing apparatus 100 for stabilizing the magnetic bearing of an electromechanical battery (EMB) system, which includes a magnetic bearing arrangement having magnetic-stabilizer bearing elements, at least two Halbach arrays 110, 120 attached to the flywheel with a fixed conductive element positioned in-between each of the Halbach arrays and a flywheel 130 of the EMB, and a control arrangement to monitor the current, in which the control arrangement detects an anomalous axial displacement of the flywheel from its equilibrium position if currents measured by the control arrangement exceed a characterized distribution of currents.

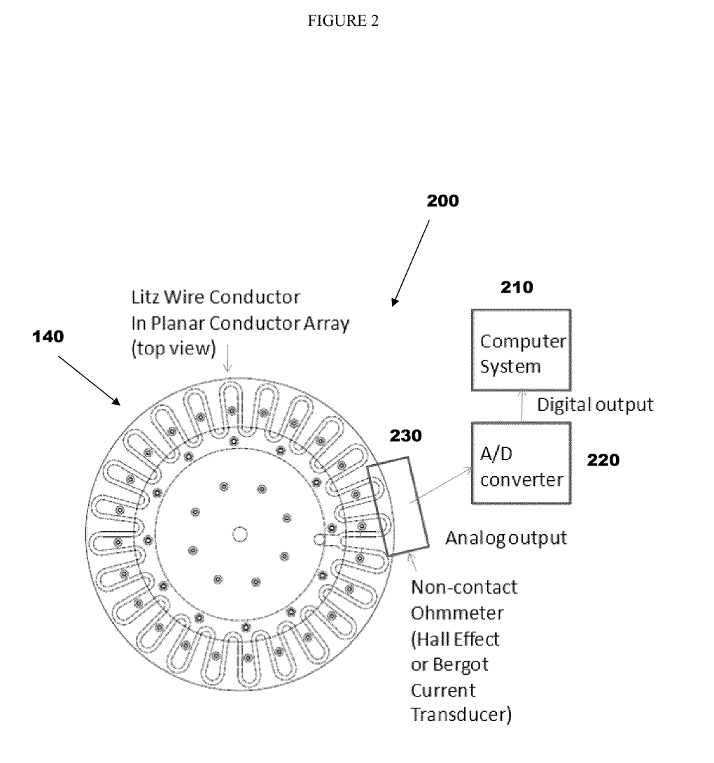

FIG. 2 shows an EMB control arrangement 20 for coupling to the Magnetic Stabilizer Bearing of the EMB.

Also, the flywheel 130 of the EMB may include a thick-walled cylinder made of filament wound glass and carbon fiber. Under normal, steady-state operations, the EMB flywheel may be magnetically levitated, and the high rotational velocity of the flywheel causes it to present gyroscopic behavior. Because the flywheel has no physical connection to its containment vessel, it is able to rotate about its axis independent of the containment vessel.

As explained above, a magnetic bearing system for an electromechanical battery (EMB) contains magnetic subsystems which act together to support a rotating element in a state of dynamic equilibrium. Stable equilibrium is achieved above a critical speed by use of a collection of passive elements using permanent magnets. In an EMB with a vertical rotational axis, levitation magnets provide radial stabilization through the predominant attractive magnetic forces between magnets on the top of the flywheel and the top of the supporting structure. However, achieving radial stabilization implies that axial stabilization along the rotational axis is unstable.

To stabilize along the axial direction, FIG. 1 shows a second set of non-centrosymmetric magnetic elements that is used in the magnetic bearing arrangement. These magnetic-stabilizer bearing elements include Halbach arrays 110, 120 attached to the flywheel 130 with a fixed conductive element (planar conductor array 140) positioned in-between. The conductive element includes wound Litz wire, which facilitates movement of surface charge due to induced magnetic fields.

When the spinning flywheel 130 moves axially away from the desired equilibrium position, one of the Halbach arrays 110,120 moves closer to the fixed conductive element, causing an electric current to produce counter-magnetic force in the fixed conductive element. This counter-magnetic force nudges the Halbach array back to the equilibrium position.

FIG. 2 shows an EMB with a control arrangement 200 coupled to the Magnetic Stabilizer Bearing of the EMB. The control arrangement 200 is used to monitor the current. Current is measured in real-time, so corrective action can be taken essentially immediately once an anomalous axial displacement condition occurs. The control arrangement 200 includes a computer system 210, which is coupled to an A/D converter 220, and which is coupled to a non-contact Ohmmeter (Hall Effect or Bergot Current Transducer) 230, which measures the currents (or corresponding or related parameters) in the planar conductor array 140.

By monitoring the current in the planar conductor array, the control arrangement of FIG. 2 can detect the excursion of the flywheel 130 from its equilibrium position. Over time, a distribution of currents is characterized for a characteristic curve.

After obtaining the characteristic curve, if the currents measured by the control arrangement subsequently exceed the characterized distribution as reflected in the characteristic curve, then the control arrangement determines that there is an anomalous axial displacement. In such a case, the flywheel operation can be corrected, slowed or stopped before a catastrophic failure occurs.

The correction, slowing or stopping of flywheel operation can be performed by passive inert gas braking (or “air-braking”) of the flywheel. In particular, the foregoing systems and methods can be used with the apparatus, system and method for air-braking the flywheel, as described in concurrently filed and co-pending utility patent application ser. no. ______ entitled “PASSIVE INERT GAS BRAKING APPARATUS, SYSTEM AND METHOD FOR BRAKING A FLYWHEEL ROTATING WITHIN AN ELECTROMECHANICAL BATTERY SYSTEM” (Attorney Docket No. 15223/10), filed Jun. 22, 2012, which is hereby incorporated by reference.

The correction, slowing or stopping of flywheel operation can be performed by passive inert gas braking (or “air-braking”) of the flywheel. In particular, the foregoing systems and methods can be used with the apparatus, system and method for air-braking the flywheel, as described in concurrently filed and co-pending provisional patent application ser. no. 61/500,382 entitled “PASSIVE INERT GAS BRAKING APPARATUS, SYSTEM AND METHOD FOR BRAKING A FLYWHEEL ROTATING WITHIN AN ELECTROMECHANICAL BATTERY SYSTEM” (Attorney Docket No. 15223/5), filed Jun. 23, 2011, which is hereby incorporated by reference.

The foregoing systems and methods can also be used with the motion protection apparatus, system and method for an electro-mechanical battery (EMB) system, as described in concurrently filed and co-pending provisional patent application ser. no. 61/500,394 entitled “MOTION PROTECTION APPARATUS, SYSTEM AND METHOD FOR AN ELECTROMECHANICAL BATTERY SYSTEM” (Attorney Docket No. 15223/6), filed Jun. 23, 2011, which is hereby incorporated by reference.

The foregoing systems and methods can be used with the apparatus, system and method for maintaining a vacuum in an EMB vacuum containment vessel of an electro-mechanical battery (EMB) system, as described in concurrently filed and co-pending provisional patent application ser. no. 61/500,355 entitled “APPARATUS, SYSTEM AND METHOD FOR PROVIDING CHEMICAL CAPTURE OF GASEOUS EMISSIONS FROM EPOXY-BONDED MATRICES OF A COMPOSITE FLYWHEEL OPERATING IN AN ELECTROMECHANICAL BATTERY SYSTEM” (Attorney Docket No. 15223/2), filed Jun. 23, 2011, which is hereby incorporated by reference.

The foregoing systems and methods can be used with the apparatus, system and method involving the incorporation of luminescent materials, such as, for example, luminescence Eu2+ doped fluorides into a flywheel of an electro-mechanical battery (EMB) system for detecting fatigue damage in the flywheel, as described in concurrently filed and co-pending provisional patent application ser. no. 61/500,370 entitled “APPARATUS, SYSTEM AND METHOD OF PRESSURE LUMINESCENT MATERIALS INCORPORATED INTO A FLYWHEEL FOR DETECTING FATIGUE DAMAGE IN THE FLYWHEEL OF AN ELECTROMECHANICAL BATTERY SYSTEM” (Attorney Docket No. 15223/3), filed Jun. 23, 2011, which is hereby incorporated by reference.

What is claimed is:

1. A magnetic-stabilizer bearing apparatus for stabilizing the magnetic bearing of an electromechanical battery (EMB) system, comprising:
a magnetic bearing arrangement having magnetic-stabilizer bearing elements;
at least two Halbach arrays attached to the flywheel with a fixed conductive element positioned in-between each of the Halbach arrays and a flywheel of the EMB; and
a control arrangement to monitor the current, wherein the control arrangement detects an anomalous axial displacement of the flywheel from its equilibrium position if currents measured by the control arrangement exceed a characterized distribution of currents.

2. The magnetic-stabilizer bearing apparatus of claim 1, wherein the control arrangement corrects, slows or stops flywheel operation before the flywheel fails.

3. The magnetic-stabilizer bearing apparatus of claim 1, wherein the conductive element includes wound Litz wire.

4. The magnetic-stabilizer bearing apparatus of claim 1, wherein the control arrangement determines an initial characteristic distribution of currents.

5. The magnetic-stabilizer bearing apparatus of claim 1, wherein the control arrangement corrects, slows or stops flywheel operation before the flywheel fails, and wherein the conductive element includes wound Litz wire.

6. The magnetic-stabilizer bearing apparatus of claim 1, wherein the control arrangement corrects, slows or stops flywheel operation before the flywheel fails, and wherein the control arrangement determines an initial characteristic distribution of currents.

7. The magnetic-stabilizer bearing apparatus of claim 1, wherein the control arrangement corrects, slows or stops flywheel operation before the flywheel fails, wherein the conductive element includes wound Litz wire, and wherein the control arrangement determines an initial characteristic distribution of currents.

8. The magnetic-stabilizer bearing apparatus of claim 1, wherein when the spinning flywheel moves axially away from a desired equilibrium position, one of the Halbach arrays moves closer to the fixed conductive element, causing an electric current to produce counter-magnetic force in the fixed conductive element to nudge the Halbach array back to the equilibrium position.

9. The magnetic-stabilizer bearing apparatus of claim 8, wherein the control arrangement corrects, slows or stops flywheel operation before the flywheel fails, and wherein the conductive element includes wound Litz wire.

10. The magnetic-stabilizer bearing apparatus of claim 8, wherein the control arrangement corrects, slows or stops flywheel operation before the flywheel fails, and wherein the control arrangement determines an initial characteristic distribution of currents.

11. The magnetic-stabilizer bearing apparatus of claim 8, wherein the control arrangement corrects, slows or stops flywheel operation before the flywheel fails, wherein the conductive element includes wound Litz wire, and wherein the control arrangement determines an initial characteristic distribution of currents.

12. A method for stabilizing a magnetic bearing of an electromechanical battery (EMB) system, the method comprising:
determining a characteristic distribution of currents of a magnetic bearing arrangement having magnetic-stabilizer bearing elements, in which at least two Halbach arrays attached to the flywheel with a fixed conductive element are positioned in-between each of the Halbach arrays and a flywheel of the EMB;
monitoring and measuring the current;
comparing the measured currents and the initial characteristic distribution of currents; and
determining that there is an anomalous axial displacement of the flywheel from its equilibrium position if the measured currents measured exceed the characteristic distribution of currents.

13. The method of claim 12, further comprising:
at least one of correcting, slowing or stopping flywheel operation before the flywheel fails.

14. The method of claim 12, wherein the conductive element includes wound Litz wire.

15. The method of claim 12, further comprising:
at least one of correcting, slowing or stopping flywheel operation before the flywheel fails;
wherein the conductive element includes wound Litz wire.

16. The method of claim 12, wherein when the spinning flywheel moves axially away from a desired equilibrium position, one of the Halbach arrays moves closer to the fixed conductive element, causing an electric current to produce counter-magnetic force in the fixed conductive element to nudge the Halbach array back to the equilibrium position.

17. The method of claim 16, further comprising:
at least one of correcting, slowing or stopping flywheel operation before the flywheel fails;
wherein the conductive element includes wound Litz wire.
